(19) United States
(12) Patent Application Publication
(10) Pub. No.: US 2015/0136518 A1
(43) Pub. Date: May 21, 2015

(54) COMPOSITE DIAPHRAGM

(71) Applicant: MERRY ELECTRONICS (SUZHOU) CO., LTD., SUZHOU CITY (CN)

(72) Inventors: Ching-Lan LIN, Taichung City (TW); Chen-Mao YANG, Taichung City (TW); Wen-Hong WANG, Taichung City (TW)

(73) Assignee: MERRY ELECTRONICS (SUZHOU) CO., LTD., SUZHOU CITY (CN)

(21) Appl. No.: 14/151,382

(22) Filed: Jan. 9, 2014

(30) Foreign Application Priority Data
Nov. 18, 2013 (TW) 102141954

(51) Int. Cl. H04R 31/00

(52) U.S. Cl. CPC H04R 31/003
USPC 181/157

(57) ABSTRACT

Provided is a composite diaphragm which includes a base layer and at least a graphyne including layer. The base layer has a central portion and a peripheral portion disposed at the periphery of the central portion. The graphyne including layer is disposed on the surface of the base layer. As graphyne is a lightweight and highly rigid material with a two-dimensional structure, composite diaphragms made of graphyne manifest characteristics, such as high stiffness, high toughness and low density, and thus achieve high practicability, such as high durability and high capability of producing high-definition tone.

### BACKGROUND OF THE INVENTION

1. Technical Field

The present invention relates to speakers, and more particularly, to a composite diaphragm for use with a speaker.

2. Description of Related Art

Due to wide use and advancement of digital media, not only is high fidelity (Hi-Fi) the trend of development of digital music, but professional speaker R&D is also all the rage. A diaphragm is one of the crucial parts of a speaker in order for the speaker to manifest excellent audio output characteristics.

Given the same size and shape, diaphragms must be stiff and tough enough to survive vigorous repetitious movement and prevent inelastic deformation or even rupture. Furthermore, diaphragms have to be of low density in order to move easily and rapidly to thereby facilitate energy distribution and provide high-definition tone.

Accordingly, it is imperative to provide a diaphragm with high stiffness, high toughness and low density.

### BRIEF SUMMARY OF THE INVENTION

It is an objective of the present invention to provide a composite diaphragm with high stiffness, high toughness and low density

In order to achieve the above and other objectives, the present invention provides a composite diaphragm which comprises a base layer and at least a graphyne including layer, wherein the graphyne including layer is disposed on the surface of the base layer.

As graphyne is a lightweight and highly rigid material with a two-dimensional structure, composite diaphragms made of graphyne manifest characteristics, such as high stiffness, high toughness and low density, and thus achieve high practicability, such as high durability and high capability of producing high-definition tone.

### BRIEF DESCRIPTION OF THE SEVERAL VIEWS OF THE DRAWINGS

FIG. 1 is a schematic cross-sectional view of a composite diaphragm according to the first embodiment of the present invention;

FIG. 2 is a schematic cross-sectional view of the composite diaphragm according to the second embodiment of the present invention;

FIG. 3 is a schematic cross-sectional view of the composite diaphragm according to the third embodiment of the present invention; and

FIG. 4 is a schematic cross-sectional view of the composite diaphragm according to the fourth embodiment of the present invention.

### DETAILED DESCRIPTION OF THE INVENTION

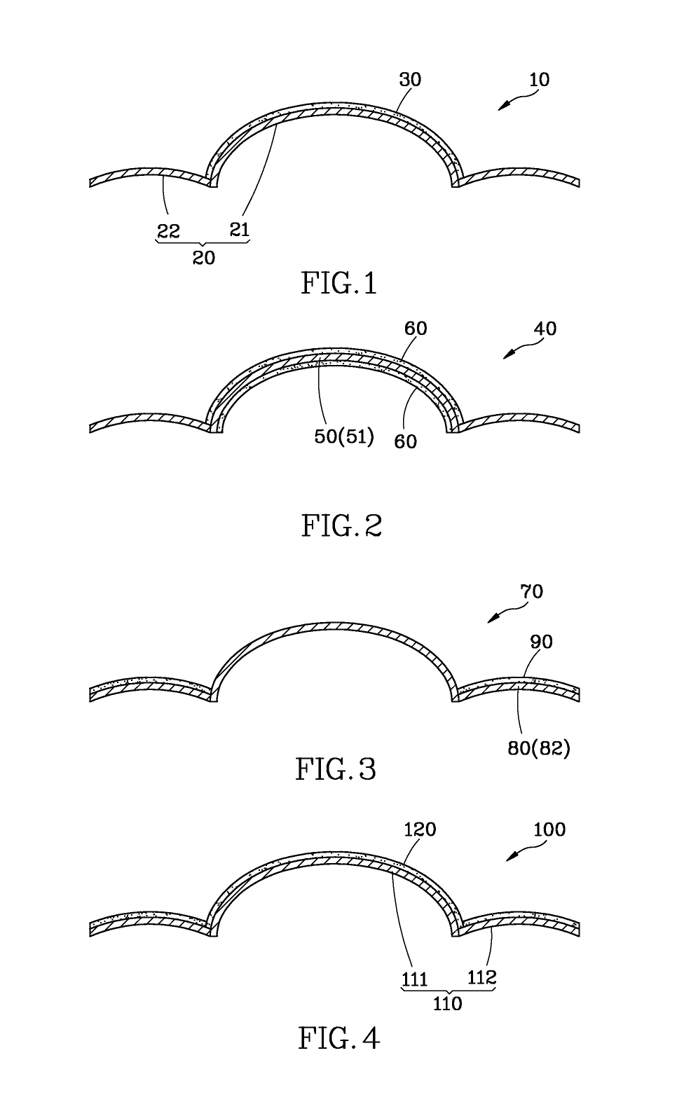

Referring to FIG. 1, in the first embodiment of the present invention, a composite diaphragm 10 comprises a base layer 20 and a graphyne including layer 30.

The base layer 20 has a central portion 21 and a peripheral portion 22 disposed at the periphery of the central portion 21. The base layer 20 is made of metal, polymer, fabric, silk, hemp, paper, or composite material. In this preferred embodiment, the central portion 21 and the peripheral portion 22 each have a curved cross-section.

The graphyne including layer 30 is disposed on the upper surface of the central portion 21 of the base layer 20. The graphyne including layer 30 is made of graphyne. Graphyne has a one-atom-thick planar structure which exists in a mixture of three hybridization states, i.e., sp, sp², sp³. That is to say, graphyne has a two-dimensional planar lattice with a full carbon molecular structure, wherein a carbon-carbon triple bond (i.e., sp hybridization state) is an important connection element of the graphyne structure; as it is insusceptible to a change in cis-trans isomers, it remains linear all the time. The graphyne can come in any one of the following structural formulas 1-4:

structural formula 1

structural formula 2

structural formula 3

structural formula 4

After it has been formed, the graphyne including layer 30 is fixed to the surface of the base layer 20 by a process, such as coating, transfer, adhesive, or fusion. Alternatively, the graphyne including layer 30 is coated directly on the surface of the base layer 20 by physical vapor deposition (PVD) or chemical vapor deposition (CVD). In a preferred embodiment of the present invention, the base layer 20 is made of metallic copper, using hexaethynyl benzene as a raw material, such that catalysis of metallic copper brings about a coupled reaction to thereby form a graphyne including layer with structural formula 3 on the copper base layer.

Referring to FIG. 2, in the second embodiment of the present invention, a composite diaphragm 40 comprises a base layer 50 and two graphyne including layers 60. The two graphyne including layers 60 are disposed on the upper surface and the lower surface of a central portion 51 of the base layer 50, respectively.

Referring to FIG. 3, in the third embodiment of the present invention, a composite diaphragm 70 comprises a base layer 80 and a graphyne including layer 90. The third embodiment is different from the first embodiment in that, in third embodiment, the graphyne including layer 90 is disposed at a peripheral portion 82 of the base layer 80.

Referring to FIG. 4, in the fourth embodiment of the present invention, a composite diaphragm 100 comprises a base layer 110 and a graphyne including layer 120. The graphyne including layer 120 covers the upper surfaces of a central portion 111 and a peripheral portion 112 of the base layer 110.

As graphyne is a lightweight and highly rigid material with a two-dimensional structure, the composite diaphragms in the aforesaid and other embodiments of the present invention manifest characteristics, such as high stiffness, high toughness and low density, and thus achieve high practicability, such as high durability and high capability of producing high-definition tone.

Constituent elements disclosed in the aforesaid embodiments of the present invention are illustrative rather than restrictive of the present invention; hence, replacements or variations of other equivalent elements should fall within the claims of the present invention.

What is claimed is:

1. A composite diaphragm, comprising:
a base layer; and
at least a graphyne including layer disposed on a surface of the base layer.

2. The composite diaphragm of claim 1, wherein the base layer further has a central portion and a peripheral portion disposed at a periphery of the central portion.

3. The composite diaphragm of claim 2, wherein the graphyne including layer is disposed on an upper surface of the central portion.

4. The composite diaphragm of claim 2, wherein there are two of the at least one graphyne including layers disposed on an upper surface and a lower surface of the central portion, respectively.

5. The composite diaphragm of claim 2, wherein the graphyne including layer is disposed at the peripheral portion.

6. The composite diaphragm of claim 1, wherein the graphyne including layer is formed by one of physical vapor deposition, chemical vapor deposition, coating, transfer, adhesive, and fusion.

7. The composite diaphragm of claim 1, wherein the base layer is made of one of metal, polymer, fabric, silk, hemp, paper, and composite material.

8. The composite diaphragm of claim 1, wherein the central portion and the peripheral portion each have a curved cross-section.
